(19) United States
(12) Patent Application Publication
(10) Pub. No.: US 2016/0311027 A1
(43) Pub. Date: Oct. 27, 2016

(54) NOZZLE, LAYERED OBJECT MANUFACTURING APPARATUS, AND METHOD FOR MANUFACTURE LAYERED OBJECT

(71) Applicant: KABUSHIKI KAISHA TOSHIBA, Minato-ku, Tokyo (JP)

(72) Inventor: Sadao SHIMOYAMA, Yokohama (JP)

(73) Assignee: KABUSHIKI KAISHA TOSHIBA, Minato-ku, Tokyo (JP)

(21) Appl. No.: 15/038,630

(22) PCT Filed: Feb. 10, 2015
(86) PCT No.: PCT/JP2015/053680

§ 371 Date: May 23, 2016

(30) Foreign Application Priority Data
Mar. 18, 2014 (JP) 2014-055661

(51) Int. Cl. B22F 7/02; B33Y 30/00; B33Y 10/00; B22F 3/105; B29C 67/00

(52) U.S. Cl. CPC B22F 7/02; B22F 3/1055; B29C 67/0077; B29C 67/0085; B33Y 10/00; B33Y 30/00; B22F 2003/1056

(57) ABSTRACT

A nozzle for a layered object manufacturing apparatus includes a material supply part and a support part. The material supply part is provided with a material supply opening through which powder of a material is supplied. The support part supports the material supply part to be movable so as to allow a change in a direction of supplying the powder.

### FIELD

Embodiments of the present invention relate to a nozzle, a layered object manufacturing apparatus, and a method for manufacturing a layered object.

### BACKGROUND

Conventionally, there has been known a layered object manufacturing apparatuses for forming layered objects. Such a layered object manufacturing apparatus manufactures a layered object by discharging powder of a material from a nozzle as well as outputting a laser beam, causing the powder to melt so that a layer of the material is formed thereby, and by forming the layer in plurality, on top of one another.

### CITATION LIST

### Patent Literature

Patent Literature 1: Japanese Patent Application Laid-open No. 2009-1900

### SUMMARY OF THE INVENTION

### Problem to be Solved by the Invention

Such a device is desired to, for example, supply the material to a shaping position more reliably or more efficiently, which is advantageous.

### Means for Solving Problem

A nozzle for a layered object manufacturing apparatus according to an embodiment of the present invention includes a material supply part and a support part. The material supply part has a material supply opening through which powder of a material is discharged. The support part supports the material supply part to be movable so as to allow a change in a direction of discharging the powder.

### BRIEF DESCRIPTION OF DRAWINGS

FIG. 1 is a diagram of an exemplary schematic configuration of a layered object manufacturing apparatus according to a first embodiment of the present invention.

FIG. 2 is a side view of an exemplary schematic configuration of a nozzle according to the first embodiment.

FIG. 3 is an explanatory diagram of an exemplary procedure of shaping (manufacturing method) by the layered object manufacturing apparatus according to the first embodiment.

FIG. 4 is a schematic sectional view of an exemplary nozzle according to the first embodiment, illustrating that powder of a material is supplied in a first direction.

FIG. 5 is a schematic sectional view of an exemplary nozzle according to the first embodiment, illustrating that powder of a material is supplied in a second direction.

FIG. 6 is a side view of an exemplary schematic configuration of part of a nozzle according to a modification of the present invention.

FIG. 7 is a side view of an exemplary schematic configuration of a nozzle according to a second embodiment of the present invention.

FIG. 8 is a flowchart of an exemplary procedure of shaping (manufacturing method) by a layered object manufacturing apparatus according to the second embodiment.

### DETAILED DESCRIPTION

Some exemplary embodiments and modifications of the present invention will be disclosed below. A configuration and control (technical features), and actions and results (effects) achieved by the configuration and the control according to the embodiments and the modifications described below are, however, merely exemplary.

Furthermore, the embodiments and the modifications disclosed below share some same elements. In the description below, the same elements are assigned with the same reference signs, and redundant explanations thereof are omitted herein.

### First Embodiment

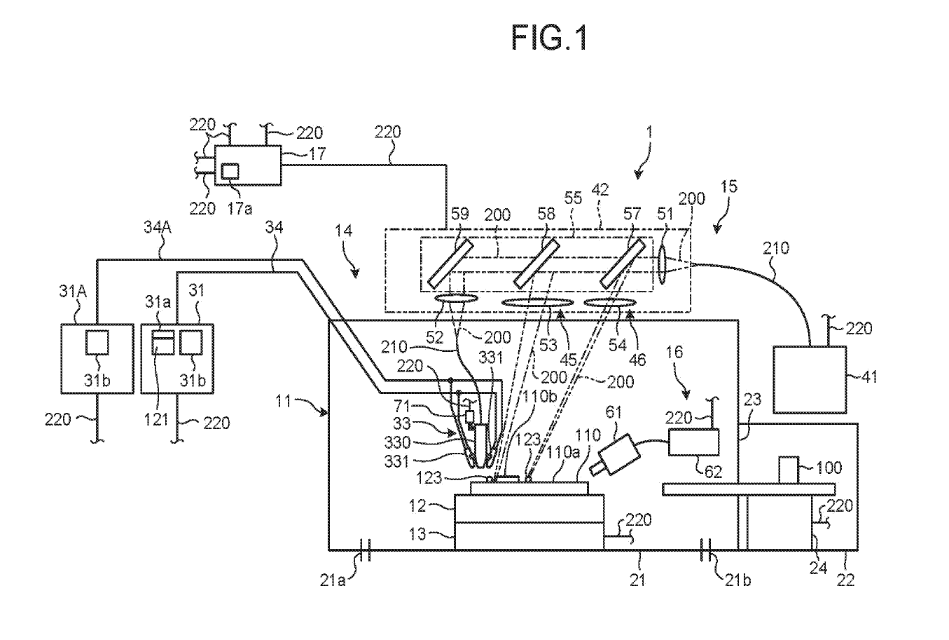

As illustrated in FIG. 1, a layered object manufacturing apparatus 1 includes a processing chamber 11, a stage 12, a moving device 13, a nozzle device 14, an optical device 15, a measuring device 16, and a control device 17.

The layered object manufacturing apparatus 1 manufactures a layered object 100 of a prescribed shape forming a plurality of layers of a material 121 supplied from the nozzle device 14 to an object 110 placed on the stage 12.

The object 110 is an object to which the material 121 is supplied by the nozzle device 14, and includes a base 110a and a layer 110b. On a top surface of the base 110a, the layers 110b are formed. Examples of the material 121 include a metal material and a resin material in powder form. One or more materials 121 may be used in shaping the layered object 100.

The processing chamber 11 has a main chamber 21 and a sub-chamber 22. The sub-chamber 22 is positioned adjacent to the main chamber 21. A door 23 is provided between the main chamber 21 and the sub-chamber 22. When the door 23 is opened, the main chamber 21 becomes communicated with the sub-chamber 22. When the door 23 is closed, the main chamber 21 is air-proofed.

The main chamber 21 is provided with a gas inlet 21a and a gas outlet 21b. By operating a gas charging device (not illustrated), inactive gas such as nitrogen or argon is supplied via the gas inlet 21a into the main chamber 21. By operating a gas discharging device (not illustrated), the gas in the main chamber 21 is discharged from the main chamber 21 via the gas outlet 21b.

Inside of the main chamber 21, a transfer device (not illustrated) is provided, and a conveyer device 24 is provided extending from the main chamber 21 into the sub-chamber 22. The transfer device passes the layered object 100 having been processed in the main chamber 21 onto the conveyer device 24. The conveyer device 24 conveys the layered object 100 passed from the transfer device into the sub-chamber 22. In other words, the layered object 100 having been processed in the main chamber 21 is stored in the sub-chamber 22. After the layered object 100 is stored in the sub-chamber 22, the door 23 is closed, so that the sub-chamber 22 is isolated. from the main chamber 21.

The stage 12, the moving device 13, a part of the nozzle device 14, the measuring device 16, and the like are provided inside of the main chamber 21.

The stage 12 supports the object 110. The moving device 13 (first moving mechanism) is capable of moving the stage 12 in three axial directions that are perpendicular to one another.

The nozzle device 14 supplies the material 121 onto the object 110 placed on the stage 12. A nozzle 33 of the nozzle device 14 irradiates the object 110, which is placed on the stage 12, with a laser beam 200. The nozzle device 14 is capable of supplying a plurality of materials 121 in parallel, and is also capable of supplying one of the materials 121 selectively. The nozzle 33 outputs the laser beam 200, in parallel with supplying the material 121. The laser beam 200 is an example of an energy beam. Any energy beam other than the laser beam may also be used, as long as such an energy beam is capable of melting the material, as the laser beam, and other examples of the energy beam include an electron beam, and an electromagnetic wave within the range from microwave to ultraviolet.

The nozzle device 14 includes a supply device 31, a supply device 31A, the nozzle 33, and a supply pipe 34. The material 121 is sent from the supply device 31 into the nozzle 33 via the supply pipe 34. The supply device 31A sends the gas into the nozzle 33 via a supply pipe 34A.

The supply device 31 includes a tank 31a and a supplying unit 31b. The tank 31a stores the material 121. The supplying unit 31b supplies a predetermined amount of the material 121 from the tank 31a. The supply device 31 supplies carrier as containing the powder material 121. The carrier gas is inactive gas, such as nitrogen or argon, for example. The supply device 31A includes the supplying unit 31b. The supply device 31A supplies the same type of gas supplied by the supply device 31.

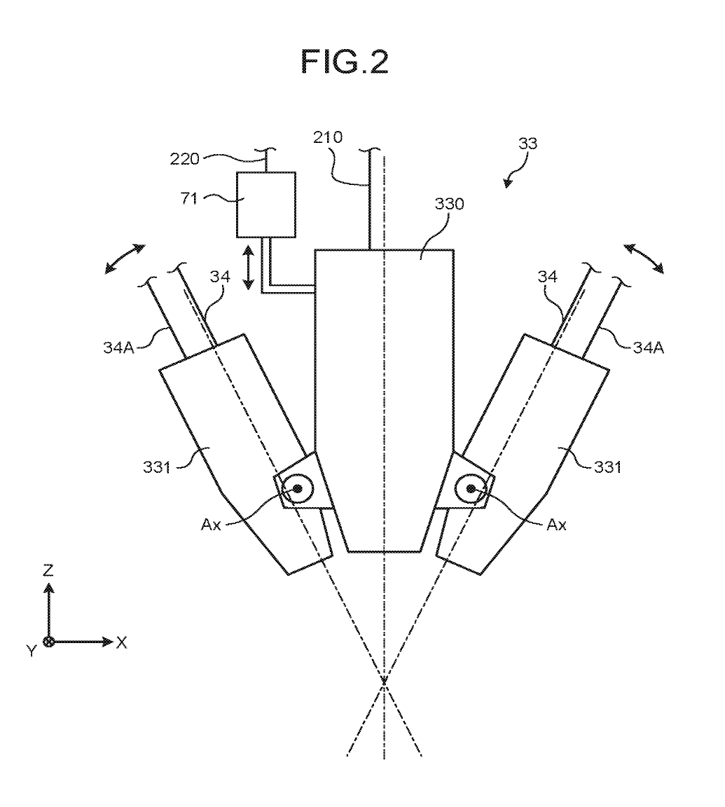

As illustrated in FIG. 2, the nozzle 33 includes an emission part 330 and one or more (for example, two) of material supply parts 331. In the following, for the purpose of illustration, an X direction, a Y direction, and a Z direction that are perpendicular to each other are defined. The X direction is left right direction in FIG. 2, the Y direction is a direction perpendicular to the drawing plane of FIG. 2, and the Z direction is the top-down direction in FIG. 2. The upper surfaces of the stage 12, the layered object 100, the object 110, the base 110a, and the layer 110b each expand substantially along a plane spanned by the X direction and the Y direction. In the layered object manufacturing apparatus 1, relative movement of the nozzle 33 and the stage 12 is achieved by moving at least one of the nozzle 33 and the stage 12 in the X and the Y directions, so that the layer 110b of the material 121 is formed along the plane defined by the X and the Y directions. The layer 110b of the material 121 is accumulated sequentially in the Z direction to form the three-dimensional layered object 100. The X and the Y directions are also referred to as the horizontal direction and the lateral direction, for example. The Z direction is also referred to as the vertical direction, the vertical direction, the height direction, the thickness direction, and the longitudinal direction, for example.

The emission part 330 is connected with an optical system 42 through a cable 210. The emission part 330 emits the laser light 200 toward a shaping position. Each material supply part 331 is supplied with powder of the material 121 from the supply device 31 through the supply tube 34 and supplied with gas from the supply device 31A through a gas supply tube 34A. The material supply part 331 supplies the material to the shaping position, and also supplies the gas separately from the material. The gas separately supplied from the material serves as shield gas.

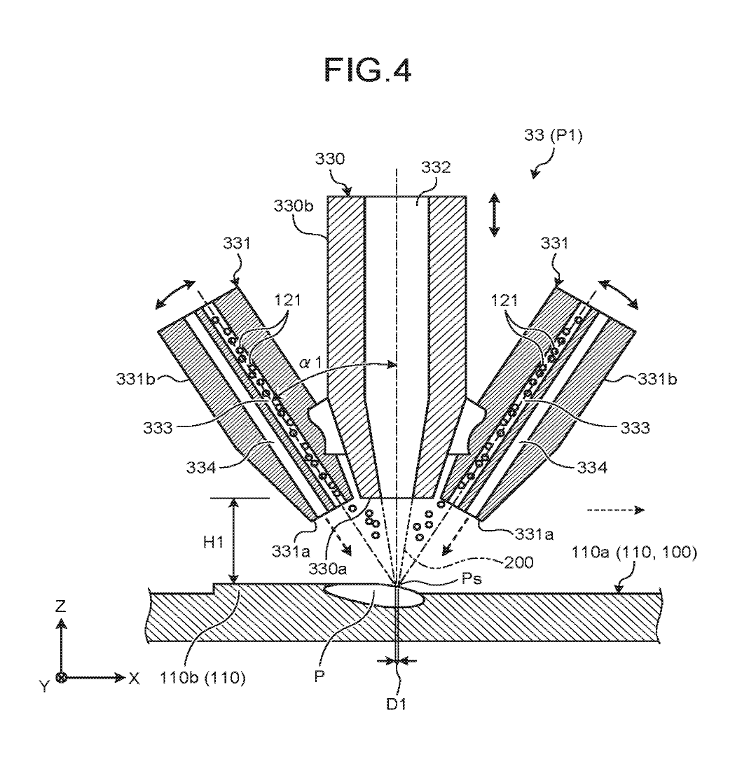

Each material supply part 331 is supported by the emission part 330 to be rotatable about a rotation center Ax. The direction (angle, orientation) of supplying the powder of the material 121 changes as the material supply part 331 rotate. The axial direction of the rotation center Ax is set to be, for example, a direction along the plane perpendicular to the emission direction of the laser light 200, and set such that, as the material supply part 331 rotates, the direction of supplying the powder of the material 121 (the axial direction of an opening 333 (refer to FIG. 4), an opening direction, the Z direction) changes along the optical path of the laser light 200 while intersecting with this optical path. The rotation angle of the material supply part 331 may be manually set or may be configured to automatically (electrically) change. The structure according to the present embodiment is not a limiting example for achieving the movable support of the material supply parts 331 to allow a change in the direction of supplying the powder of the material 121. The material supply parts 331 may be, for example, supported by the emission part 330 to be slidable, in other words, movable. For example, the material supply parts 331 may be supported to be movable along the emission direction (the top-down direction in FIG. 2) of the laser light 200. The emission part 330 is an exemplary support part.

A move device 71 can change the position of the nozzle 33. The move device 71 changes the position of the nozzle 33 along the emission direction of the laser light 200, and changes the distance between the nozzle 33 and the shaping position. The move device 71 is connected with the control device 17 through a signal line 220. The move device 71 can move the nozzle 33 in the vertical direction in FIG. 2. The move device 71 includes, for example, a linear actuator, a motor, and a link mechanism.

As illustrated in FIG. 1, the optical device 15 includes a light source 41 and an optical system 42. The light source 41 includes an oscillator device (not illustrated), and outputs the laser beam 200 through the oscillation of the oscillator device. The light source 41 is capable of changing the power density of a laser beam to be output.

The light source 41 is connected to the optical system 42 over a cable 210. The laser beam 200 output from the light source 41 becomes incident on the nozzle 33 via the optical system 42. The nozzle 33 then irradiates the object 110 and the material 121 that is discharged onto the object 110 with the laser beam 200.

Specifically, the optical system 42 includes a first lens 51, a second lens 52, a third lens 53, a fourth lens 54, and a galvano scanner 55. The first lens 51, the second lens 52, the third lens 53, and the fourth lens 54 are fixed. The optical system 42 may also include an adjusting device capable of moving the first lens 51, the second lens 52, the third lens 53, and the fourth lens 54 in two axial directions, more specifically, in directions intersecting with (e.g., orthogonal to) the light path.

The first lens 51 converts the laser beam 200 being incident via the cable 210 to the parallel light. The converted laser beam 200 then becomes incident on the galvano scanner 55.

The laser beam 200 output from the galvano scanner 55 is converged by the second lens 52. The laser beam 200 converged by the second lens 52 is passed through the cable 210, and reaches the nozzle 33.

The laser beam 200 output from the galvano scanner 55 is converged by the third lens 53. The object 110 is then irradiated with the laser beam 200 converged by the third lens 53.

The laser beam 200 output from the galvano scanner 55 is converged by the fourth lens 54. The object 110 is then irradiated with the laser beam 200 converged by the fourth lens 54.

The galvano scanner 55 splits the parallel light converted by the first lens 51 into light rays incident on the second lens 52, the third lens 53, and the fourth lens 54, respectively. The galvano scanner 55 includes a first galvano mirror 57, a second galvano mirror 58, and a third galvano mirror 59. The galvano mirrors 57, 50, and 59 are capable of splitting light, and changing their inclination angle (output angle).

A part of the laser beam 200 having passed through the first lens 51 passes through the first galvano mirror 57, and the passed laser beam 200 becomes incident on the second galvano mirror 58. The first galvano mirror 57 reflects the other part of the laser beam 200, and. the reflected laser beam 200 becomes incident on the fourth lens 54. The first galvano mirror 57, by changing the inclination angle thereof, changes the position irradiated with the laser beam 200 having passed through the fourth lens 54.

A part of the laser beam 200 having passed through the first galvano mirror 57 passes through the second galvano mirror 58, and the passed laser beam 200 becomes incident on the third galvano mirror 59. The second galvano mirror 58 reflects the other part of the laser beam 200, and the reflected laser beam 200 becomes incident on the third lens 53. The second galvano mirror 58, by changing the inclination angle of thereof, changes the position irradiated with the laser beam 200 having passed through the third lens 53.

The third galvano mirror 59 outputs a part of the laser beam 200 passed through the second galvano mirror 58 to the second lens 52.

In the optical system 42, the first galvano mirror 57, the second galvano mirror 58, and the third lens 53 implement a melting device 45. The melting device 45 serves to form a layer 110b and to perform annealing, by heating the material 121 (123) that is supplied from the nozzle 33 to the object 110, by outputting the laser beam 200.

The optical system 42 also implements a removing apparatus 46 for removing the material 121. The removing apparatus 46 removes any unnecessary portion that is formed on the base 110a or on the layer 110b, by outputting the laser beam 200. Specifically, the removing apparatus 46 removes any part not making up a predetermined shape of the layered object 100, including any unnecessary portion of the material 121 scattered when the material 121 is supplied from the nozzle 33, and any unnecessary portion formed when the layer 110b is formed. The removing apparatus 46 outputs the laser beam 200 at a power density sufficient for removing such unnecessary portions.

The measuring device 16 measures the shape of the layer 110b having been solidified, and the shape of the layered object 100 having been formed. The measuring device 16 transmits information of the measured shape to the control device 17. The measuring device 16 includes a camera 61 and an image processing device 62, for example. The image processing device 62 performs image processes based on information measured by the camera 61. The measuring device 16 measures the shape of the layer 110b and the layered object 100 using optical interferometry, light-section method, for example.

The moving device 71 (first moving mechanism) is capable of moving the nozzle 33 in three axial directions that are orthogonal to one another.

The control device 17 is electrically connected to the moving device 13, the conveyer device 24, the supply device 31, the supply device 31A, the light source 41, the galvano scanner 55, the image processing device 62, and the moving device 71 (refer to FIG. 2), via a signal wire 220.

The control device 17 moves the stage 12 in the three axial directions by controlling the moving device 13. The control device 17 conveys the formed layered object 100 into the sub-chamber 22 by controlling the conveyer device 24. The control device 17 controls whether to supply the material 121, and adjusts the amount of the material to be supplied, by controlling the supply device 31. The control device 17 adjusts the power density of the laser beam 200 to be output from the light source 41 by controlling the light source 41. The control device 17 adjusts the inclination angles of the first galvano mirror 57, the second galvano mirror 58, and the third galvano mirror 59 by controlling the galvano scanner 55. The control device 17 also controls the position of the nozzle 33, by controlling the moving device 71.

The control device 17 is provided with a storage unit 17a. The storage unit 17a stores therein data representing the shape of the layered object 100 to be formed (reference shape), for example. The storage unit 17a also stores therein data representing the height of the nozzle 33 and the height of the stage 12 at each three-dimensional processing position (point).

The control device 17 may have a function of supplying a plurality of different materials 121 from the nozzle 33 selectively, and adjusting (changing) the ratio of the materials 121. For example, the control device 17 controls the supply device 31 and the like based on the data representing the ratio of the materials 121 stored in the storage unit 17a so that the layer 110b of the materials 121 is formed at that ratio. This function enables shaping of a graded material (functionally graded material) in which the ratio of the materials 121 changes (degreases or increases gradually) across the positions (locations) of the layered object 100. Specifically, when a layer 110b is formed, the layered object 100 can be shaped as a graded material (functionally graded material) in which the ratio of the materials 121 changes in some three-dimensional directions by the control device 17 controlling the supply device 31 to yield the ratio of the materials 121 set (stored) for respective positions in the three-dimensional coordinates of the layered object 100, for example. The amount of change in the ratio of the material 121 (the ratio of change) per unit length can be set variously.

The control device 17 has a function of determining the shape of the material 121. For example, the control device 17 determines whether there is any portion that is outside of the predetermined shape, by comparing the shape of the layer 110b or the shape of the layered object 100 acquired by the measuring device 16 with the reference shape stored in the storage unit 17a.

The control device 17 also has a function of trimming the material 121 to the predetermined shape by removing the unnecessary portion determined to be outside of the predetermined shape, in the determination of the shape of the material 121. For example, if the material 121 becomes scattered and adheres to a portion that is outside of the predetermined shape, the control device 17 first controls the light source 41 in such a manner that the laser beam 200 output from the fourth lens 54 via the first galvano mirror 57 is brought to have the power density capable of vaporizing the material 121. The control device 17 then controls the first galvano mirror 57, and vaporizes the material 121 by irradiating the portion with the laser beam 200.

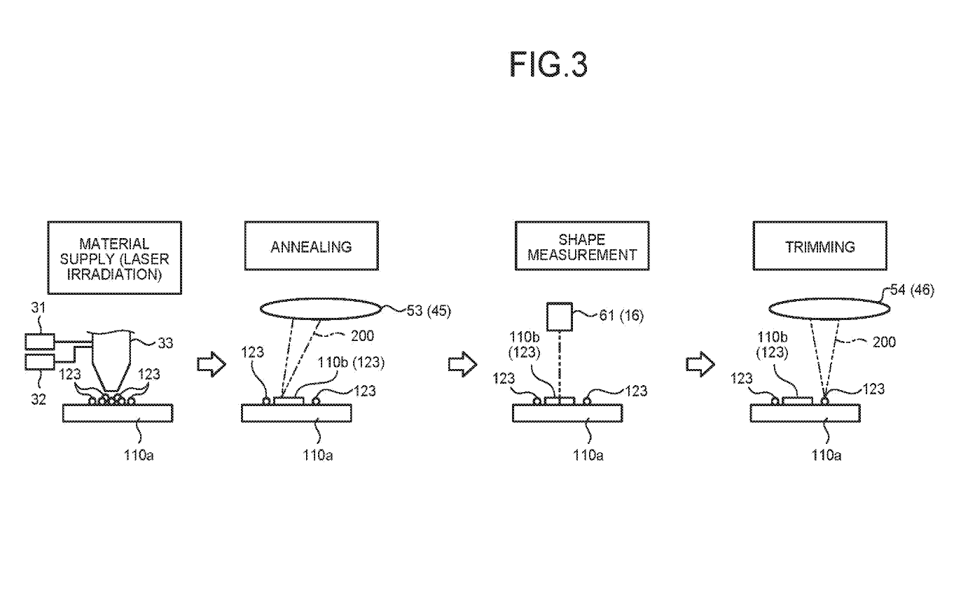

A method for manufacturing the layered object 100 with the layered object manufacturing apparatus 1 will now be explained with reference to FIG. 3. As illustrated in FIG. 3, to begin with, the material 121 is supplied, and irradiated with the laser beam 200. The control device 17 controls the supply devices 31 and 31A, and the like so that that the material 121 is supplied from the nozzle 33 to a predetermined area, and controls the light source 41, the galvano scanner 55, and the like so that the supplied material 121 is caused to melt with the laser beam 200. In this manner, the molten material 123 is supplied, in a predetermined amount, to the area on which the layer 110b is to be formed on the base 110a, as illustrated in FIG. 2. When the material 123 is discharged onto the base 110a or the layer 110b, the material 123 deforms, and is turned into a layer-like or thin-film-like aggregation of the material 123. When the material 123 is cooled by the gas (gas) carrying the material 121, or cooled by the heat transfer to the aggregation of the material 121, the material 123 accumulates granularly, and forms a granular aggregation.

The layered object manufacturing apparatus 1 then performs the annealing. The control device 17 controls the light source 41, the melting device 45, and the like in such a manner that the aggregation of the material 123 on the base 110a is irradiated with the laser beam 200. In this manner, the aggregation of the material 123 is caused to melt again, and is turned into the layer 110b.

The layered object manufacturing apparatus 1 the measures the shape. The control device 17 controls the measuring device 16 to measure the material 123 on the base 110a having been applied with the annealing. The control device 17 compares the shape of the layer 110b or the shape of the layered object 100 acquired by the measuring device 16 with the reference shape stored in the storage unit 17a.

The layered object manufacturing apparatus 1 then performs trimming. If the material 123 on the base 110a is determined to adhere to a position in a shape outside of the predetermined shape, for example, through the shape measurement and the comparison with the reference shape, the control device 17 controls the light source 41, the removing apparatus 46, and the like to vaporize the unnecessary material 123. If the layer 110b is determined to have the predetermined shape through the shape measurement and the comparison with the reference shape, the control device 17 does not perform the trimming.

When the formation of the layer 110b described above is completed, the layered object manufacturing apparatus 1 forms another layer 110b on top of the layer 110b. The layered object manufacturing apparatus 1 forms the layered object 100 by accumulating the layers 110b repetitively.

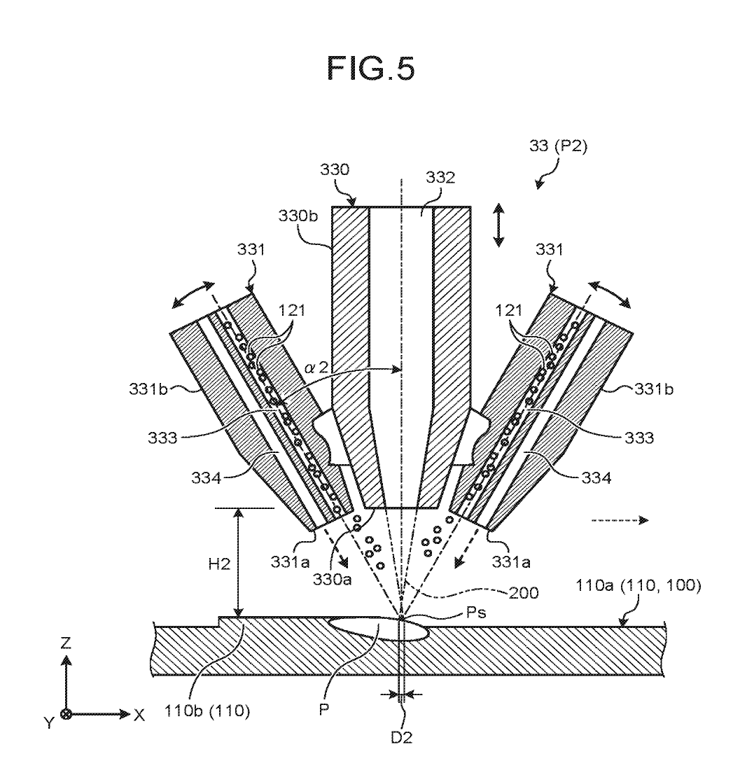

The following describes an exemplary configuration and function of the nozzle 33 according to the present embodiment in detail with reference to FIGS. 4 and 5. The nozzle 33 includes the emission part 330 and the one or more (for example, two) material supply parts 331. The emission part 330 has an elongate shape and is made of high heat-resistant material such as boron nitride (ceramic material). The longitudinal direction (axial direction) of the emission part 330 is along the Z direction, for example. The transverse direction (width direction) of the emission part 330 is along the X or Y direction, for example. The emission part 330 has a cylindrical appearance, for example. The emission part 330 has, at its end in the emission direction of the laser light 200, a tapered part that is narrower toward the emission direction. The emission part 330 includes a bottom surface 330a and a side surface 330b as its outer surfaces (surfaces). The bottom surface 330a is positioned at an end (lower end) of the emission part 330 in the longitudinal direction and is also referred to as an end surface. The bottom surface 330a faces the stage 12, the layered object 100, and the object 110, for example. The bottom surface 330a is formed as a plane. The side surface 330b is positioned at an end of the emission part 330 in the width direction and is also referred to as a peripheral surface. The side surface 330b is formed as a cylindrical surface.

An opening 332 provided on a central part of the bottom surface 330a of the emission part 330. The opening 332 extends along the longitudinal direction of the emission part 330. The opening 332 has a section along the width direction, in other words, a section perpendicular to the longitudinal direction, which is circular. The opening 332 may be formed to have a diameter gradually decreasing toward a head. The laser light 200 is introduced into the opening 332 through, for example, the cable 210 (refer to FIG. 1). The opening 332 is a path of the laser light 200 and is an exemplary emission opening.

Each material supply part 331 has an elongate shape, and is made of a metal material, for example. The longitudinal direction (axial direction) of the material supply part 331 is, for example, along a direction (oblique direction) intersecting with the XY plane and the Z direction. The material supply part 331 has a cylindrical appearance having a tapered part. The material supply part 331 includes a bottom surface 331a and a side surface 331b as its outer surfaces (surfaces). The bottom surface 331a is positioned at an end (lower end) of the material supply part 331 in the longitudinal direction and is also referred to as an end surface. The bottom surface 331a faces the stage 12, the layered object 100, and the object 110, for example. The bottom surface 331a is formed as a plane. The side surface 331b is positioned at an end of the material supply part 331 in the width direction and is also referred to as a peripheral surface. The side surface 331b is formed as a cylindrical surface.

The bottom surface 331a of the material supply part 331 has the opening 333 and an opening 334. The openings 333 and 334 extend in parallel to each other along the longitudinal direction of the material supply part 331. The opening 333 is positioned closer to the center of the emission part 330 than the opening 334 (on a central axis side of the opening 334) is. The openings 333 and 334 have sections along the width direction, in other words, sections perpendicular to the longitudinal direction, which are circular.

The opening 333 is connected with the supply device 31 through, for example, the supply tube 34 (refer to FIG. 1). The opening 333 is on a path through which the powder of the material 121 is supplied onto a process region (shaping position Ps). The opening 334 is connected with the supply device 31A through, for example, the supply tube 34A (refer to FIG. 1). The opening 334 is on a path through which gas is supplied onto the process region. The gas supplied from the opening 334 is used as shield gas, for example. The section of the opening 334 along the width direction may have a shape (for example, an arc or a C shape) surrounding the opening 333 from a side opposite to the opening 332.

As illustrated in FIGS. 4 and 5, the laser light 200 (optical path) emitted toward the object 110 from the emission part 330 is focused on the object 110. Thus, diameters D1 and D2 of the laser light 200 at the shaping position Ps (irradiate position) can be changed by changing the distance between the nozzle 33 and the object 110 (distance in the Z direction), in other words, the position of the nozzle 33 in the Z direction. The diameter of the laser light 200 is smallest when the laser light 200 is most condensed, and from this state, increases as the distance between the nozzle 33 and the object 110 increases, and increases as the distance between the nozzle 33 and the object 110 decreases. FIG. 4 illustrates that the nozzle 33 is positioned at a position P1, and FIG. 5 illustrates that the nozzle 33 is positioned at a position P2 farther away from the surface of the object 110 than the position P1. In other words, a distance H2 between the bottom surface 330a of the emission part 330 and the shaping position Ps (the surface of the object 110) when the nozzle 33 is positioned at the position P2 (FIG. 5) is larger than a stance Hi therebetween when the nozzle 33 is positioned at the position P1 (FIG. 4) (H2>H1). In this case, the diameter D1 of the laser light 200 at the shaping position Ps when the nozzle 33 is positioned at the position P1 (FIG. 4) is smaller than the diameter D2 of the laser light 200 at the shaping position Ps when the nozzle 33 is positioned at the position P2 (FIG. 5) (D1<D2). A smaller diameter of the laser light 200 at the shaping position Ps allows more precise shaping at higher accuracy, whereas a larger diameter allows faster shaping. Thus, by changing the position of the nozzle 33, the layered object manufacturing apparatus 1 according to the present embodiment is capable of executing the shaping with the smaller diameter D1 at a site (the shaping position Ps) where shaping at higher accuracy is required as illustrated in FIG. 4, and with the larger diameter D2 at a site (the shaping position Ps) where faster shaping is required as illustrated in FIG. 5, for example. This facilitates achievement of an improved accuracy and speeding of the shaping.

According to the present embodiment, in the nozzle 33 including the material supply parts 331 arranged around the emission part 330, the powder of the material 121 from each material supply part 331 is supplied obliquely to the optical path of the laser light 200 as illustrated in FIGS. 4 and 5. If the posture (angle) of the material supply part 331 with respect to the emission part 330 is fixed (constant), the direction (orientation) of supplying the powder of the material 121 from the material supply part 331 remains unchanged, and thus the distance of a supply position of the powder of the material 121 from the bottom surface 330a of the emission part 330 is unchanged. Accordingly, as described above, when the distance between the nozzle 33 and the object 110 is changed to change the diameter of the laser light 200, for example, this makes it difficult to supply the powder of the material 121 onto the shaping position Ps. Specifically, when the nozzle 33 is moved to the upper sides in FIGS. 4 and 5, the supply position of the powder of the material 121 is moved to the upper sides as well. The material supply part 331 according to the present embodiment is, however, capable of changing the direction (orientation) of supplying the powder of the material 121. As illustrated in FIGS. 4 and 5, an angle α1 between the emission part 330 and the material supply part 331 when the nozzle 33 is positioned at the position P1 (FIG. 4) is larger than an angle α2 therebetween when the nozzle 33 is positioned at the position P2 (FIG. 5). It is obvious that, since the angles α1 and α2 (posture) of the material supply part 331 are set as appropriate in accordance with the position of the nozzle 33, the direction of supplying the powder of the material 121 from the opening 333 can be prevented from shifting from the shaping position Ps. When the powder of the material 121 is being supplied, the posture (angle) of the material supply part 331 relative to the emission part 330 is fixed, for example. The posture of the material supply part 331 can be fixed by using a fixture (connector such as screw; not illustrated). In this case, such a configuration is possible that the posture of the material supply part 331 can be changed (adjusted) by releasing or loosening the fixation by the fixture.

As described above, in the present embodiment, the direction of supplying the powder of the material 121 from the material supply part 331 can be changed by rotating (moving) the material supply part 331. Thus, for example, the powder of the material 121 can be supplied more reliably or more efficiently. According to the present embodiment, for example, the single nozzle 33 can be used in place of a plurality of nozzles used in a conventional device. Thus, the efficiency of supplying the powder of the material 121 can be increased, and the layered object manufacturing apparatus 1 can be configured smaller, which are advantages.

The nozzle 33 includes a plurality of the material supply parts 331 that can change the direction of supplying the powder of the material 121. Thus, for example, the powder of the material 121 can be supplied faster, and unevenness (variation) of the powder of the material 121 is reduced as compared to a case of supplying the powder of the material 121 from the single material supply part 331, which are advantages.

In the layered object manufacturing apparatus 1, the powder of the material 121 is supplied in a first direction from the material supply parts 331 to the shaping position Ps (first shaping position) illustrated in FIG. 4, and simultaneously the laser light 200 is emitted from the emission part 330, so as to perform shaping at this shaping position Ps (first shaping position). The powder of the material 121 is supplied in a second direction from the material supply parts 331 to the shaping position Ps (second shaping position) illustrated in FIG. 5, and simultaneously the laser light 200 is emitted from the emission part 330, so as to perform shaping at this shaping position Ps (second shaping position). Accordingly, the powder of the material 121 can be more reliably or more efficiently supplied based on the shaping position Ps, for example.

### Modification of First Embodiment

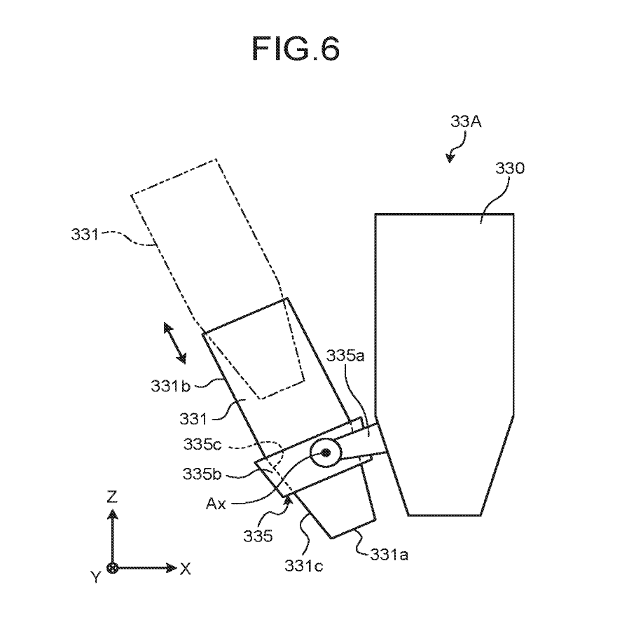

A nozzle 33A according to the present modification illustrated in FIG. 6 has the same configuration as that of the above-described embodiment. Thus, the present modification can achieve the same results (effects) based on the same configuration as that of the above-described embodiment. Although FIG. 6 only illustrates the single material supply part 331, the nozzle 33A according to the present modification may include plurality of the material supply parts 331. However, in the present modification, each material supply part 331 are detachably supported by the emission part 330 (support part). Specifically, a tapering surface 331c is formed at a head part of the side surface 331b of the material supply part 331. The emission part 330 is provided with a holder 335 that detachably supports the material supply part 331. The holder 335 includes an arm 335a and a movable portion 335b. The arm 335a protrudes from the emission part 330. The arm 335a is fixed to the emission part 330. The movable portion 335b is supported by the arm 335a to be rotatable about the rotation center Ax. The axial direction of the rotation center Ax is set as, for example, a direction along the plane perpendicular to the emission direction of the laser light 200, and is set such that, as the movable portion 335b and the material supply part 331 mounted on this movable portion 335b rotate, the direction (the axial direction of the opening 333, the opening direction, the Z direction) of supplying the powder of the material 121 changes along the optical path of the laser light 200 while intersecting with this optical path. While the powder of the material 121 is being supplied, the movable portion 335b is fixed to the emission part 330 at a set posture (angle), for example. The movable portion 335b is formed as a circle (ring) and has a cone-shaped support surface 335c (inner surface) within the circle. The support surface 335c has a shape (curvature radius, tilt, and the like) corresponding to the tapering surface 331c provided to the material supply part 331. The material supply part 331 is inserted into the movable portion 335b toward the lower side of FIG. 6 from the upper side of FIG. 6 to a position at which the support surface 335c contacts with the tapering surface 331c, and is fixed (connected) with the movable portion 335b at this position with the fixture (connector such as screw; not illustrated). The material supply part 331 can be removed from the movable portion 335b by releasing the fixation by the fixture. An angle between the arm 335a and the movable portion 335b may be fixed by fixing the fixture. This configuration in which the material supply part 331 is detachable from the emission part 330 (support part) allows the material supply part 331 to be replaced more easily, for example. This achieves various kinds of effects such as easier maintenance of the material supply part 331 and easer replacement of the material supply part 331 with the material supply part 331 that supplies powder of another material 121. The holder 335 is an exemplary support part. This detachable configuration is not limited to the modification.

### Second Embodiment

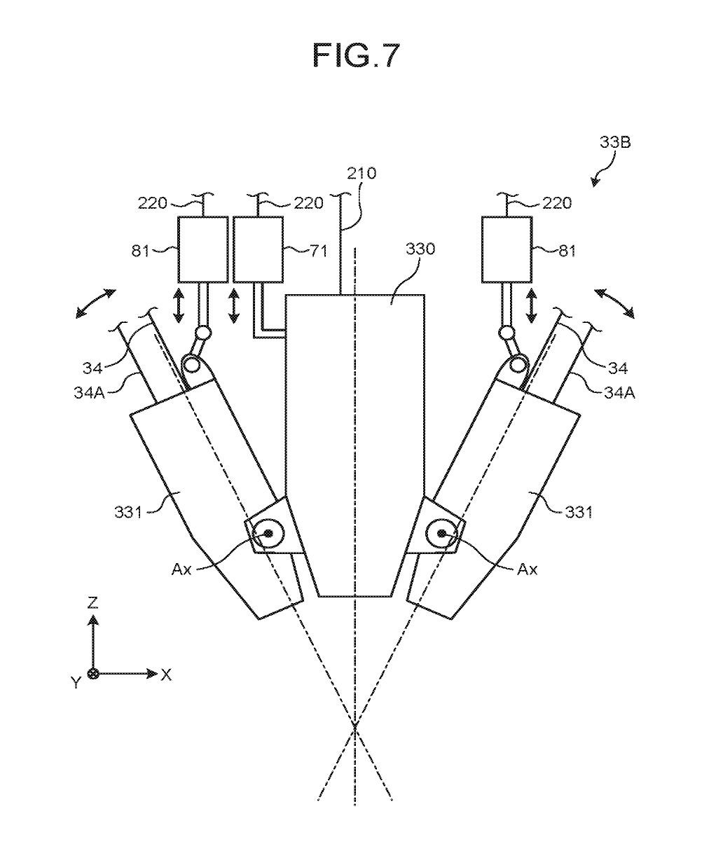

A nozzle 33B according to the present modification has the same configuration as those of the above-described embodiment and modification. Thus, in the present embodiment, the same result (effect) based on the same configuration as those of the above-described embodiment and modification is obtained. However, as illustrated in FIG. 7, the nozzle 33B according to the present embodiment includes a move device 81 that changes the posture of the corresponding material supply part 331. The move device 81 is electrically connected with the control device 17 (refer to FIG. 1) through the signal line 220. The move device 81 includes a linear actuator, a motor, and a link mechanism. The control device 17 controls the move device 81 so that the material supply part 331 has a desired posture. The control device 17 can control the control device 17 so that the posture of the material supply part 331 does not change (is maintained) during shaping. The storage unit 17a (FIG. 1) of the control device 17 stores therein information (data) used for the control of the posture of the move device 81. The move device 81 is an exemplary second move device.

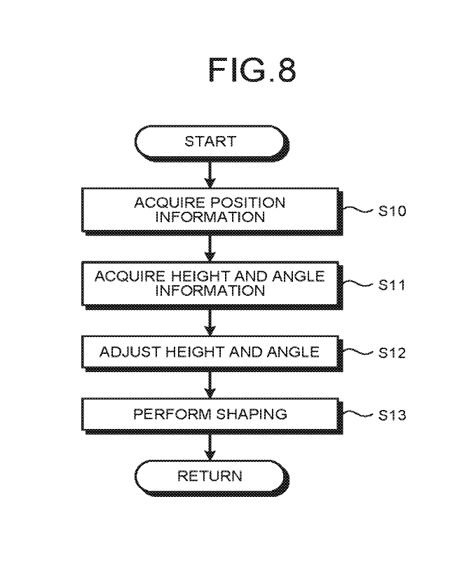

The following describes a procedure of adjusting (changing) the posture of each material supply part 331 in the nozzle 33B with reference to FIG. 8. First, the control device 17 acquires position information on the shaping position Ps (refer to FIG. 4) of the nozzle 33B (S10). The position information may be, for example, information on three-dimensional position coordinates of the shaping position Ps, information on each layer 110b, and information on each region in the layer 110b. Next, the control device 17 acquires information on the height of the nozzle 336 and the angle of the material supply part 331 corresponding to the shaping position Ps (S11). This height and angle information used at S11 is stored in the storage unit 17a in association with the position information. The height, information may be, for example, a control amount of the move device 71, whereas the angle information may be, for example, a control amount of the move device 81. The height and angle information may be data indicating the height and angle, or may be information on parameters corresponding to the height and angle. Next, the control device 17 controls the move devices 71 and 81 based on the height and angle information acquired at S11 (S12). Accordingly, the nozzle 33B, in other words, the emission part 330 and the material supply part 331 have desired positions and postures (angle) corresponding to the shaping position Ps. Specifically, as illustrated in FIGS. 4 and 5, each shaping position Ps is irradiated with the laser light 200 having the diameters D1 and D2 corresponding to this shaping position Ps, and the powder of the material 121 is supplied in the direction corresponding to the shaping position Ps. The diameters D1 and D2 may be set in association with the position information. Next, the control device 17 performs shaping at the shaping position Ps through the nozzle 33B having desired position and posture (S13). The layered object manufacturing apparatus 1 performs this processing to form the layer 110b (refer to FIGS. 4 and 5).

As described above, the control device 17 (control unit) controls the move, device, 81 (second move mechanism) in accordance with a change in the distance between the shaping position Ps and the nozzle 33B (the material supply parts 331) so as to change the direction of supplying the powder of the material 121 from the material supply parts 331. Accordingly, for example, the powder of the material 121 can be more reliably or more efficiently supplied at the shaping position Ps.

In the layered object manufacturing apparatus 1, the diameter of the laser light 200 at the shaping position Ps changes with a change in the distance between the shaping position Ps and the nozzle 335 (the material supply parts 331). Thus, the diameter of the laser light 200 can be changed relatively easily. Accordingly, the accuracy and efficiency of shaping can be improved easily. With a function to change this diameter, it is possible to more reliably or more efficiently supply the powder of the material 121 at the shaping position Ps.

In the layered object manufacturing apparatus 1, the direction of supplying the powder of the material 121 from each material supply part 331 changes with a change in the diameter of the laser light 200. Thus, the powder of the material 121 is more reliably or more efficiently supplied based on the change of the diameter. The change of the diameter of the laser light 200 can be achieved without moving the nozzle 33B. In other words, the powder of the material 121 can be more reliably or more efficiently supplied at the shaping position Ps when the diameter of the laser light 200 changes without the movement of the nozzle 33B.

Although some exemplary embodiment and modifications of the present invention are explained above, these embodiment and modifications are merely exemplary, and are not intended to limit the scope of the present invention in any way. These embodiment and modifications may be implemented in different ways, and various omission, replacements, combinations, and modifications are still possible within the scope not deviating from the essence of the present invention. The embodiment and the modifications of the embodiment fall within the scope and the essence of the present invention, and are within the scope of the present invention described in the appended claims and their equivalent. The present invention may be implemented differently from the configurations and control (technical features) disclosed in the embodiment and the modifications. Furthermore, with the present invention, at least one of the various results (including the effects and the derivative effects) achieved by the technical features can be achieved. For example, the direction of discharging the powder material may be changed depending on a change in the inside of the material supply part or the carrier gas without the posture or the position of the material supply part being changed.

For example, the layered object manufacturing apparatus may be configured or used so that powders of different materials are supplied from a plurality of material supply parts. In this case, the amounts and ratio of the powders of materials supplied from the respective material supply parts may be variably controlled. For example, the layered object manufacturing apparatus may configured such that the material supply parts supply the powders of the materials at supply amounts that depend on a three-dimensional shaping position, so as to shape a gradient material (functional gradient material) in which the ratio of materials gradually changes in a two-dimensional or three-dimensional manner. The supply position of each material by the corresponding material supply part (the direction, posture, angle, position, and the like of the material supply part) may be variably controlled in accordance with the kind and flow amount (supply amount, discharge amount) of the material.

1-13. (canceled)

14. A nozzle for a layered object manufacturing apparatus, the nozzle comprising:
an emission part configured to emit an energy beam;
a material supply part provided with a material supply opening through which powder of a material is discharged; and
a support part provided to the emission part and supporting the material supply part to be movable.

15. The nozzle according to claim 14, wherein the material supply part is supported by the support part so as to allow a change in a direction of discharging the powder.

16. The nozzle according to claim 14, wherein the material supply part is supported by the support part to be slidable.

17. The nozzle according to claim 16, wherein the material supply part is supported by the support part to be slidable along an emission direction of the energy beam.

18. The nozzle according to claim 14, wherein the material supply part is detachably provided to the support part.

19. The nozzle according to claim 14, wherein the material supply part includes a plurality of material supply parts.

20. A layered object manufacturing apparatus comprising:
a light source configured to generate an energy beam;
an emission part configured to emit the energy beam;
a material supply part provided with a material supply opening through which powder of a material is discharged, and supported by the emission part to be movable; and
a first move mechanism configured to change a relative position between a shaping position and the material supply part.

21. The layered object manufacturing apparatus according to claim 20, wherein the material supply part is supported by the emission part to allow a change in a direction of discharging the powder through the material supply opening.

22. The layered object manufacturing apparatus according to claim 21, wherein
a second move mechanism configured to move the material supply part; and
a control unit configured to control the second move mechanism.

23. The layered object manufacturing apparatus according to claim 22, wherein the first move mechanism allows a change in a distance between a shaping position and the material supply part.

24. The layered object manufacturing apparatus according to claim 23, wherein a diameter of an energy beam at the shaping position changes.

25. The layered object manufacturing apparatus according to claim 22, wherein the control unit controls the second move mechanism so that the direction of discharging the powder changes with a change in a diameter of an energy beam at the shaping position.

26. The layered object manufacturing apparatus according to claim 22, wherein the material supply part is supported by the emission part to be slidable.

27. The layered object manufacturing apparatus according to claim 14, wherein the material supply part is supported by the emission part to be slidable along an emission direction of the energy beam.

28. A method for manufacturing a layered object, the method comprising:
shaping by discharging powder of a material to a first shaping position at a first angle from the material supply part of the layered object manufacturing apparatus according to claim 20 and irradiating the first shaping position with the energy beam from the emission part; and
shaping by discharging the powder of the material to a second shaping position at a second angle from the material supply part and irradiating the second shaping position with the energy beam from the emission part.
